(19) United States
(12) Patent Application Publication
(10) Pub. No.: US 2015/0206520 A1
(43) Pub. Date: Jul. 23, 2015

(54) Cymbal carrying cases and related methods

(71) Applicants: Tracy Hoeft, Clearwater, FL (US); Doughlas Webber, Safety Harbor, FL (US)

(72) Inventors: Tracy Hoeft, Clearwater, FL (US); Doughlas Webber, Safety Harbor, FL (US)

(21) Appl. No.: 14/603,014

(22) Filed: Jan. 22, 2015

Related U.S. Application Data
(60) Provisional application No. 61/930,398, filed on Jan. 22, 2014.

(51) Int. Cl. G10G 7/00; B65D 81/02; B65D 25/28; G10D 13/06; B65D 25/10

(52) U.S. Cl. CPC G10G 7/005; G10D 13/065; B65D 25/10; B65D 25/28; B65D 81/02

(57) ABSTRACT

Disclosed is a cymbal case for retaining a plurality of cymbals, said briefcase containing: a padded first compartment with a lift for creating an air-pocket between the padding and a cymbal retained therein; and padded second compartment with a clutch receptacle and support for receiving and supporting the clutch of a hi-hat cymbal and clutch assembly.

### CROSS-REFERENCE TO RELATED APPLICATIONS

This application claims the benefit and priority of U.S. Prov. Pat. App. Ser. No.: 61/930,398 (filed Jan. 22, 2014) and entitled Cymbal carrying cases and related methods. This document is incorporated in its entirety as if fully set forth herein.

### STATEMENT REGARDING FEDERALLY SPONSORED RESEARCH OR DEVELOPMENT

Not applicable.

### FIELD OF INVENTION

This application is in the field of cymbal carrying cases.

### BACKGROUND OF THE INVENTION

Cymbals are a percussion musical instrument. Cymbals are typically defined by round metal plates or bowls that produce noise when struck. Frequently, cymbals are mounted to a stand and struck with a mallet or drum stick to produce sound. Just as frequently, two opposing cymbals are struck together. In a drum kit, for instance, some cymbals (e.g., crash, ride, and splash cymbals) are mounted to a stand to be struck with a drumstick while other cymbals (e.g., hi-hat cymbals) are placed on a foot-pedal driven piston and clapped together.

The sound quality of cymbals can be affected by denting or cracking of the cymbal. As a result, cymbals are often carried in a protective case whenever the cymbals are moved between two locations. For instance, one type of known case is a padded circular or square briefcase wherein cymbals are nested in the main compartment. See e.g., U.S. Pub. Pat. App. Ser. No. 2010/0252464 to Belitz (which discloses an air cushioned circular briefcase); see also, e.g., U.S. Pat. No. 6,448,482 by Cero (which discloses a square briefcase with cushioned foam pockets).

Although useful in many situations, briefcase type protective cases have not always been satisfactory for carrying cymbals. In many instances, briefcase type protective cases subject the edges of contained cymbals to damage whenever the cases are set-down in an upright position. Even with padding, large forces are focused on the edge of the cymbal when the briefcase is uprightly set-down, and said forces can damage the cymbal. Also, briefcase style cymbal cases are not entirely suitable for hi-hat cymbals because the hi-hat cymbal must be entirely disassembled before it can be nested in the compartment of the briefcase so that its components, like its clutch for coupling the cymbal to a piston, do not (a) cause damage to the other cymbals or (b) cause damage to itself. Entire disassembly of the hi-hat cymbal is cumbersome and time-consuming when setting up or taking down a hi-hat cymbal. What is worse, disassembly of the hi-hat cymbal can result in the loss of the clutch during transport. In view of the foregoing, a need exists for cymbal cases that do not damage the edges of its cymbals when set down and that can accommodate a hi-hat cymbal and its clutch without disassembly.

One briefcase type cymbal case is known for protecting an assembled hi-hat cymbal. U.S. Pat. No. 5,088,377 to Delecaris discloses a padded circular briefcase with a dome on one of its sides for accommodating the clutch of an assembled hi-hat cymbal. While capable of retaining a hi-hat cymbal, the case is limited in that multiple types of cymbals cannot be carried in the same case. The Delecaris case is also limited in that the case is (1) bulky and hard to carry; and (2) made for a hi-hat cymbal that is installed on a stand. Furthermore, the briefcase disclosed by Delecaris is not adequately configured to protect the edges of a cymbal deposited therein. Thus, a need exists for cymbal cases that do not damage the edges of its cymbals when set down and that can accommodate a plurality of cymbals, including a hi-hat cymbal and its clutch without disassembly.

### SUMMARY OF THE INVENTION

In view of the foregoing, it is an objective of this disclosure to describe a cymbal case that protects the edges of its cymbals when set down.

It is a further objective of this disclosure to describe a cymbal case that is capable of retaining a plurality of cymbals, including a hi-hat cymbal and clutch assembly.

In a preferred embodiment, the disclosed cymbal case is a briefcase for retaining a plurality of cymbals, said briefcase containing: a padded first compartment with a lift for creating an air-pocket between the padding and a cymbal retained therein; and a padded second compartment with a clutch receptacle and support for receiving and supporting the clutch of a hi-hat cymbal and clutch assembly.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 is a perspective view of a cymbal case 1000;

FIG. 2 is a front view of the cymbal case 1000 of FIG. 1;

FIG. 3 is a right-side view of the cymbal case 1000 of FIG. 1;

FIG. 4 is a left side view of the cymbal case 1000 of FIG. 1;

FIG. 5 is a top view of the cymbal case 1000 of FIG. 1;

FIG. 6 is a bottom view of the cymbal case 10000 of FIG. 1;

FIG. 7 is a back view of the cymbal case 1000 of FIG. 1;

FIG. 8 is a perspective view of another configuration of the cymbal case 1000 of FIG. 1;

FIG. 9 is a front view of the cymbal case 1000 in the configuration of FIG. 8;

FIG. 10 is a front view of an alternate embodiment of a cymbal case in the configuration of FIG. 8;

FIG. 11 is a cross section of the cymbal case 1000 taken along line A-A of FIG. 5;

FIG. 12 is a cross section of the cymbal case 1000 taken along the line B-B of FIG. 5;

FIG. 13 is a cross section of an alternate cymbal case 100 taken along line A-A of FIG. 5; and,

FIG. 14 is a cross section of the alternate cymbal case 1000 of FIG. 13, taken along the line B-B of FIG. 5.

It is to be noted, however, that the appended figures illustrate only typical embodiments of the disclosed apparatus and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a cymbal case (a) that protects the edges of its cymbals when set down and (b) that is capable of retaining a plurality of cymbals, including a hi-hat cymbal and clutch assembly. In general, the disclosed cymbal case is a briefcase for retaining a plurality of cymbals, said briefcase containing: a padded first compartment with a lift for creating an air-pocket between the padding and a cymbal retained therein; and a padded second compartment with a clutch receptacle and support for receiving and supporting the clutch of a hi-hat cymbal and clutch assembly. The more specific aspects of the disclosed case are disclosed with reference to the drawings.

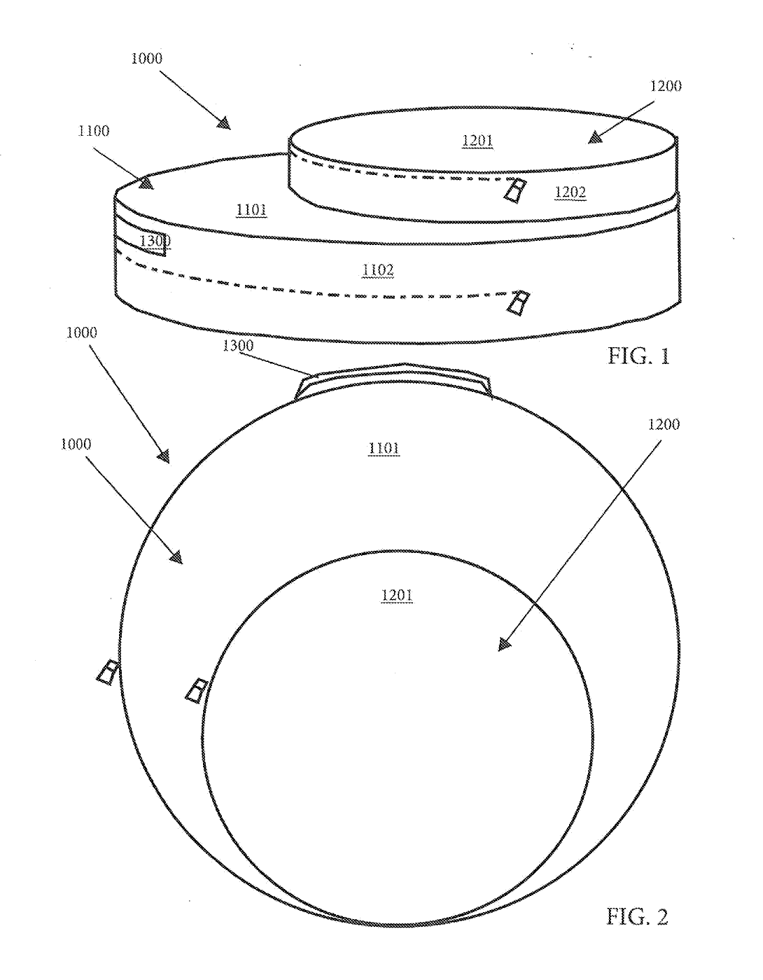

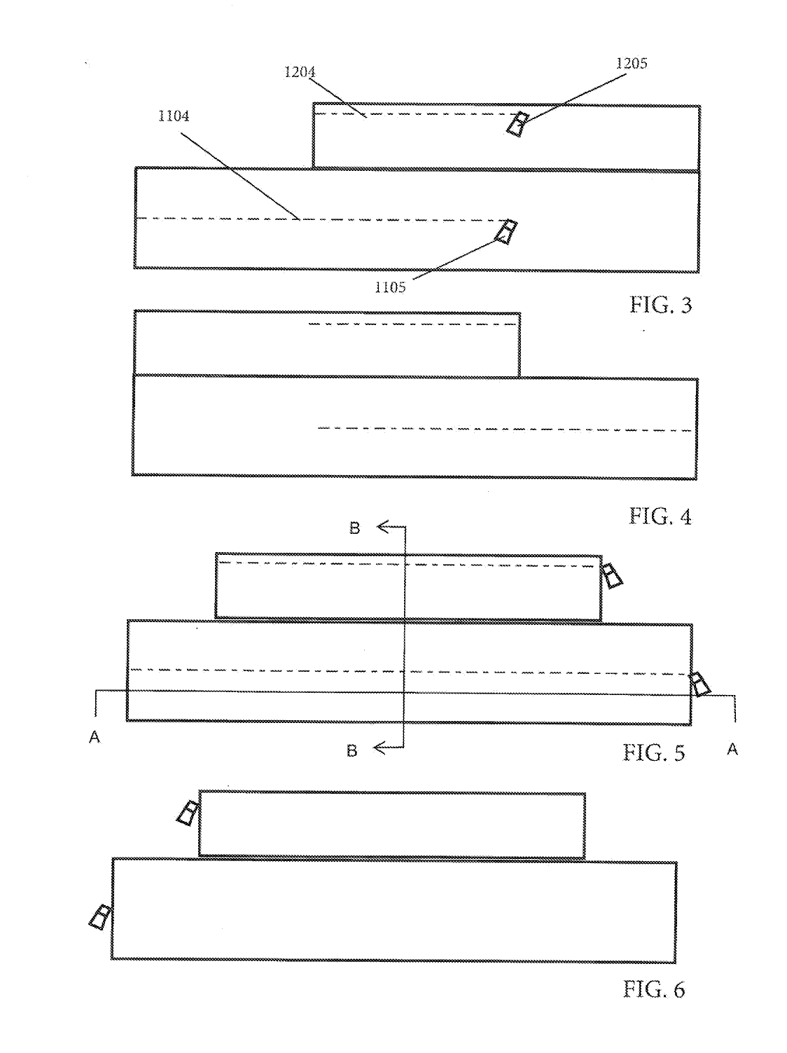

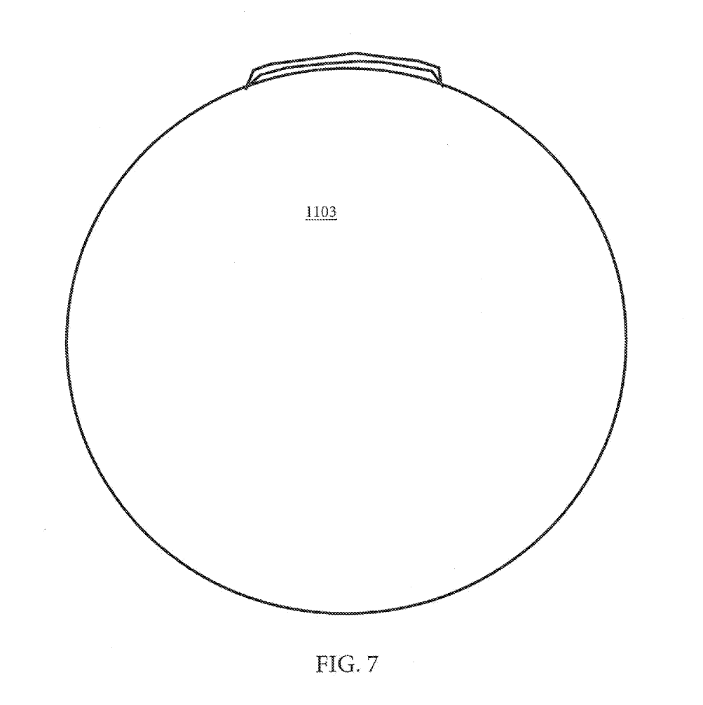

FIG. 1 is a perspective view of a preferred embodiment of a cymbal case 1000. FIGS. 2 through 7 are respectively, front, right-side, left-side, top, bottom, and back views of the cymbal case 1000. As shown in those figures, the cymbal case 1000 is defined by a first compartment 1100, a second compartment 1200, and a handle 1300.

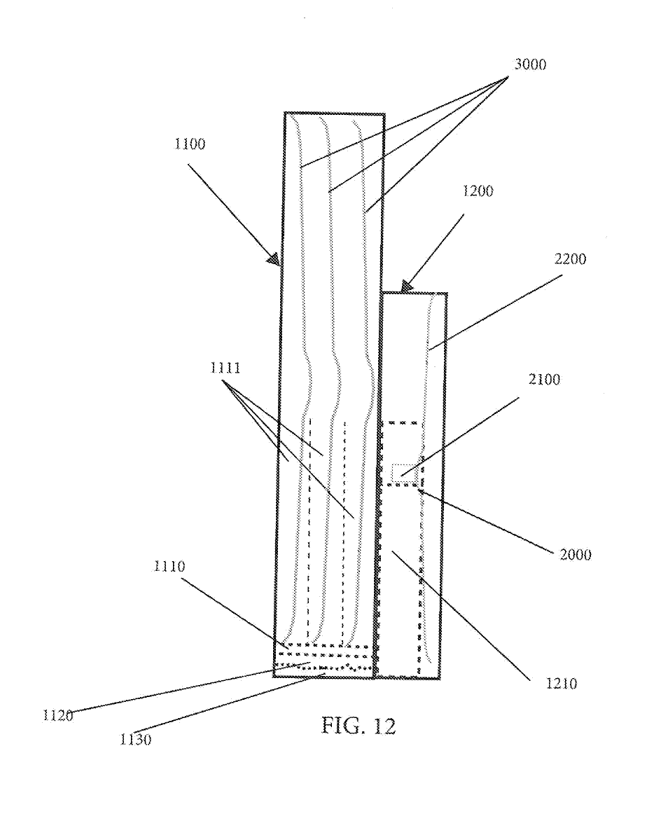

FIGS. 1 through 7 illustrate the first compartment 1100. As shown, the first compartment 1100 suitably provides a volume for retaining cymbals (See FIG. 12, 3000). The volume of the first compartment 1100 is preferably defined within a front wall 1101, a side wall 1102 and a back wall 1103. The volume of the first compartment 1100 may preferably be accessed via an opening 1104 through the side wall 1102. Suitably, the opening may be electively closable by a zipper 1105.

The second compartment 1200 is also illustrated in FIGS. 1 through 7. As shown, the second compartment 1200 suitably provides a volume for retaining a cymbal 3000. The volume of the second compartment 1200 is preferably defined within a front wall 1201, a side wall 1202 and the front wall 1101 of the first compartment 1100. The volume of the first compartment 1100 may preferably be accessed via an opening 1204 through the side wall 1202. Suitably, the opening may be electively closable by a zipper 1205.

In one embodiment, the handle 1300 and first and second compartments 1100, 1200 may be constructed of materials suitable for protective cases and luggage. In a preferred embodiment the handle 1300 and first and second compartments 1100, 1200 are constructed of fabric materials, including, but not limited to, polyesters. Other durable fabrics or plastics may be used to construct the first and second compartments 1100, 1200. Also, it should be noted that other closure mechanisms, like snaps or Velcro, may be used in lieu of zippers.

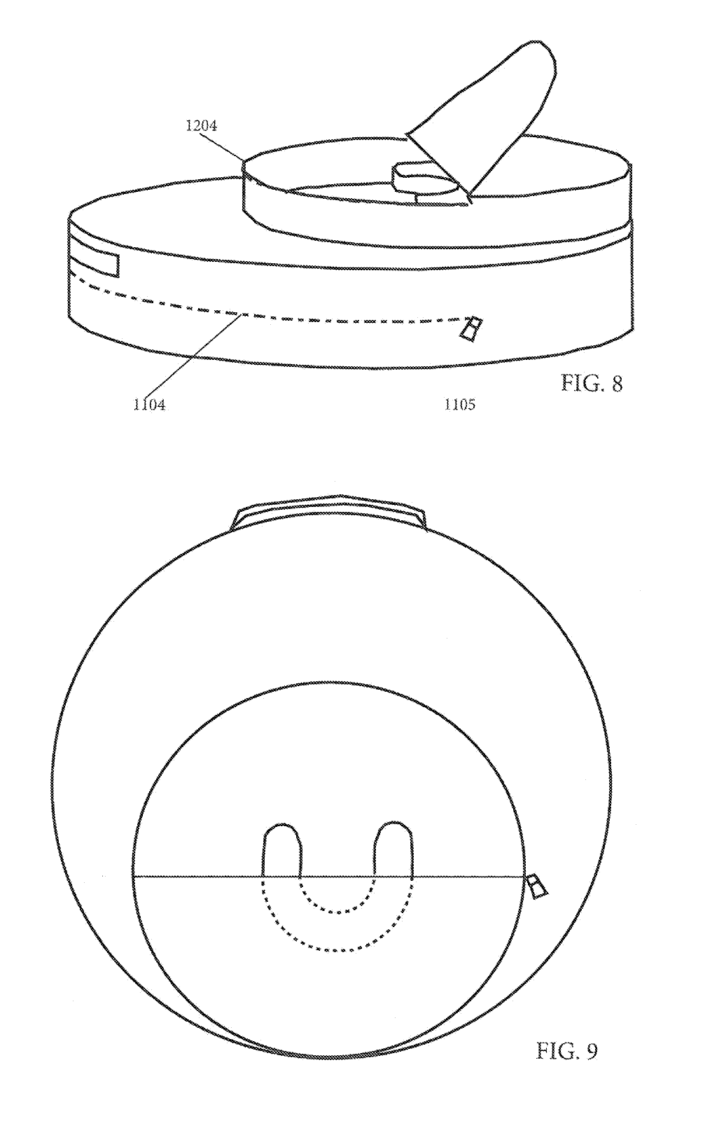

FIG. 8 is a perspective view of another configuration of the cymbal case 1000 of FIG. 1. FIG. 9 is a front view of the cymbal case 1000 in the configuration of FIG. 8. In the depicted configuration, the second compartment 1200 is open (i.e., with the opening 1204 unzipped) to reveal a receptacle 1210 for a clutch of a hi-hat cymbal (See FIG. 12, 2000). In FIG. 9, part of the receptacle 1210 that is in the second compartment and not exposed via the opening 1204 is shown in broken lines. As shown, the receptacle 1210 is defined by a semi-circular projection inside of the second compartment 1200.

FIG. 12 is a cross section of the cymbal case 1000 taken along the line B-B of FIG. 5. FIGS. 8, 9 and 12 illustrate a preferred mode of operation for the second compartment 1200. Referring to FIGS. 8, 9, and 12, in a preferred mode of operation, the clutch 2100 of a hi-hat cymbal 2000 may be directed into the compartment 1200 so that the clutch 2100 is retained within the receptacle 1210 while the plate 2200 of the cymbal projects radially therefrom into the second compartment 1200. Suitably, the receptacle 1210 supports the hi-hat plate 2200 while the clutch 2100 of the cymbal 2000 is retained with the center portion of the receptacle 1210. After positioning the hi-hat cymbal 2000 and clutch 2100 assembly into the second compartment 1200, the second compartment may be closed via zipping the zipper 1205 over the opening 1204.

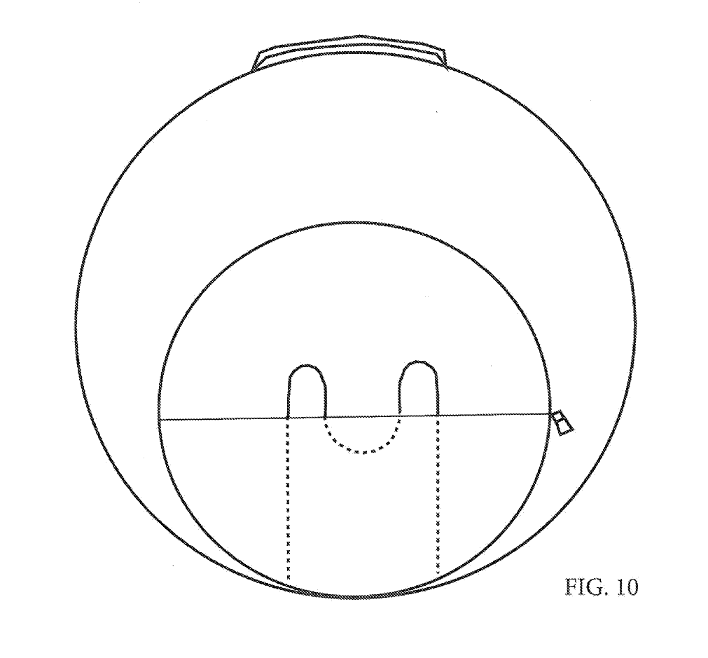

FIG. 10 is a front view of an alternate embodiment of a cymbal case in the configuration of FIG. 8. In the alternate embodiment, the receptacle 1210 may be extended all the way to the bottom of the second compartment 1200 to increase the support provided to a cymbal 3000 deposited therein the second compartment 1200. Suitably, the alternate embodiment may operate in the same manner disclosed above.

The clutch receptacle 1210 is constructed of stiff foam or other rigid or semi-rigid materials. In another embodiment, the receptacle 1210 is gel-filled. In one embodiment, the receptacle 1210 is covered in velvet or other soft and non-abrasive materials constructed of fabrics or plastics.

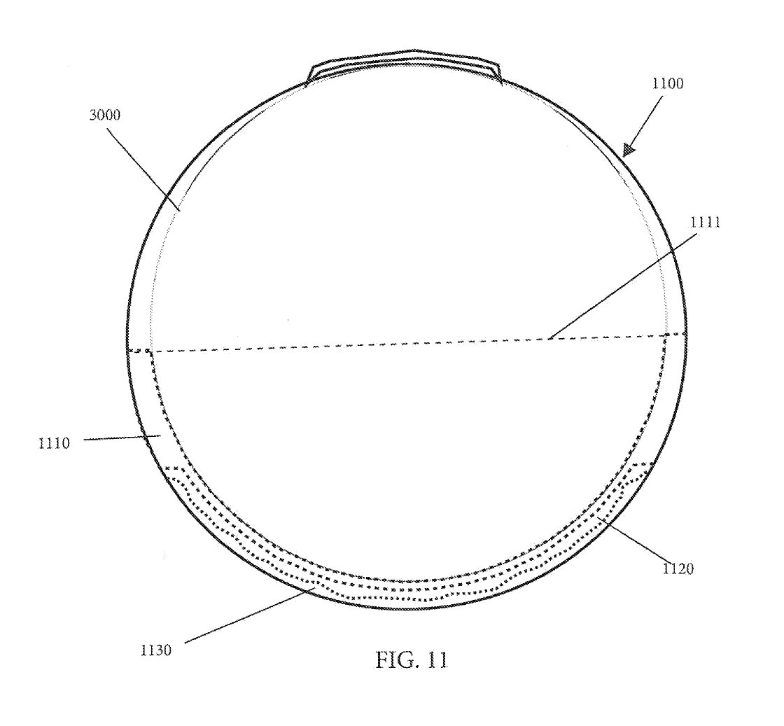

FIG. 11 is a cross section of the cymbal case taken along line A-A of FIG. 5. As mentioned above, FIG. 12 is a cross section of the cymbal case 1000 taken along the line B-B of FIG. 5. When viewed together, FIGS. 11 and 12 illustrate the configuration and operation of the first compartment 1100.

Referring to FIG. 11, the first compartment 1100 contains a lift 1110, an air pocket 1120, and padding 1130. As shown, the lift 1110 features a plurality of receptacles 1111 for retaining cymbals 3000. The lift 1110 is coupled to the padded sidewall and positioned so that an air pocket 1120 is created between the padding 1130 and the lift 1110. In a preferred embodiment, the separation from the lift 1110 and the padding 1130 by the air pocket 1120 protects the edges of the cymbals 3000 from damage whenever the case 1000 is set down.

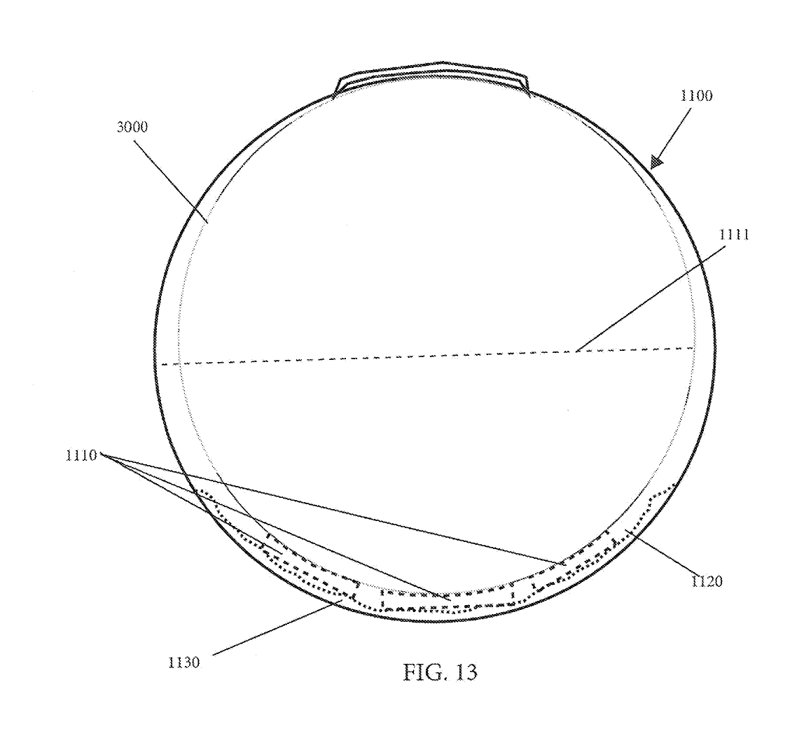

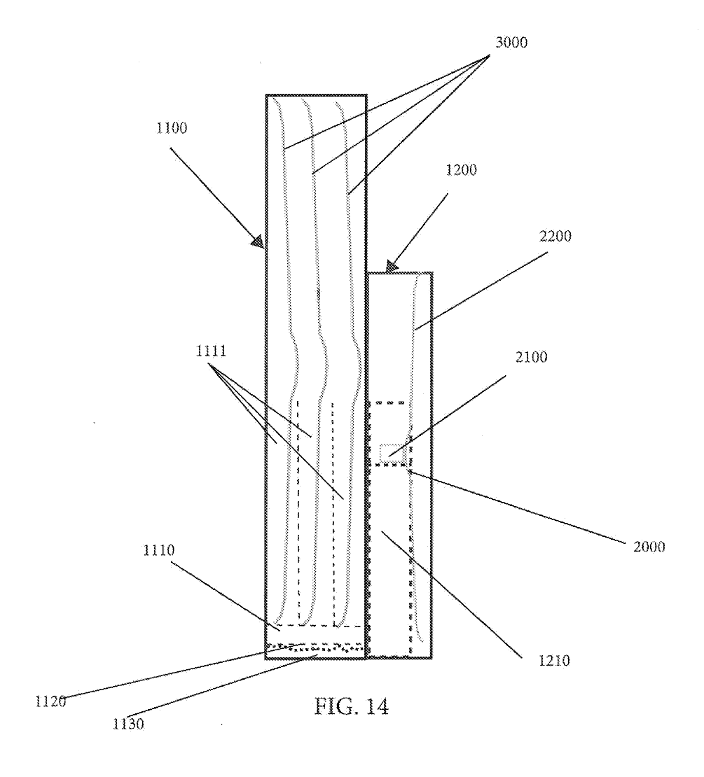

FIGS. 13 and 14 illustrate the lift 1110 in an alternate embodiment. In the depicted embodiment, the lift 1110 is defined by three foam pieces that project toward the center of the compartment to create the air pocket 1120 above the padding 1130. The modes of operation for the lift 1110 are the same as disclosed above in connection with FIGS. 11 and 12.

It should be noted that this disclosure describes a preferred embodiment and is not intended to be limiting of the possible embodiments that could be used to accomplish the invented cymbal cases. Those of skill in the art may readily appreciate other useful and equally preferred embodiments of the disclosed cymbal cases after reading this disclosure and such embodiments would not depart from the spirit and intent of this disclosure.

All features disclosed in this specification, including any accompanying claims, abstract, and drawing, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step of” in the clause as specified in 35 U.S.C. §112, paragraph 6 may not be intended as a means plus claim.

We claim:

1. A cymbal briefcase for retaining a plurality of cymbals, said briefcase comprising:
a padded first compartment with a lift for creating an air-pocket between the padding and a cymbal retained therein; and
a padded second compartment with a clutch receptacle and support for receiving and supporting the clutch of a hi-hat cymbal and clutch assembly.
